(19) United States
(12) Patent Application Publication
(10) Pub. No.: US 2024/0397889 A1
(43) Pub. Date: Dec. 5, 2024

(54) APPARATUS AND METHOD FOR SPROUTING SEEDS

(71) Applicants: Baskar Sikkayan, Santa Clara, CA (US); Samiksha Shri Baskar, Santa Clara, CA (US)

(72) Inventors: Baskar Sikkayan, Santa Clara, CA (US); Samiksha Shri Baskar, Santa Clara, CA (US)

(21) Appl. No.: 18/783,456

(22) Filed: Jul. 25, 2024

(51) Int. Cl. A01G 31/02

(52) U.S. Cl. CPC A01G 31/02

(57) ABSTRACT

The present invention discloses an apparatus and method for sprouting seeds. The apparatus comprises a loading chamber with an open upper end for receiving seeds and dispensing a predefined quantity upon command, disposed in an operative upright position. A soaking chamber, engaged with the lower end of the loading chamber, receives the predefined quantity of seeds. The apparatus includes a liquid inlet coupled to the soaking chamber, delivering a predetermined amount of liquid for soaking the seeds. A sprouting chamber, engaged with the lower end of the soaking chamber, receives the seeds post-soaking and maintains a controlled environment for the required sprouting period. Finally, a collection chamber, coupled to the lower end of the sprouting chamber, receives the sprouted seeds upon completion of the sprouting period.

### FIELD

The present invention relates to a germinating apparatus, and more particularly to an apparatus and method for sprouting seeds in a controlled environment.

### BACKGROUND

The process of sprouting, which involves mass germinating of vegetable seeds for food, is commonly performed using mason jars at home. However, this method, while simple, requires frequent manual rinsing/watering of the sprouts throughout their growth cycle. This manual intervention can be inconvenient and may lead to suboptimal crop growth or increased risks of fungal/bacterial contamination if not executed correctly.

Commercial sprouting devices typically utilize large drums filled with seeds and water, mechanized to facilitate germination and growth. However, these conventional devices are prone to mechanical failures due to their multi-axis actuation, resulting in costly repairs. Furthermore, they are expensive to acquire, demand significant space, and necessitate packaging the finished sprouts in plastic for refrigerated transportation to retailers. During shipping, the sprouts may be compromised at various points, and their shelf life is limited to just a few days.

Thus, there exists a need for a portable and user-friendly sprouting apparatus that minimizes manual intervention and reduces mechanical failures. Additionally, this apparatus should enable an efficient process that minimizes sprout spoilage and enhances nutritional content. Consequently, an alternative apparatus for sprouting seeds is proposed.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

According to an embodiment, an apparatus for sprouting seeds is disclosed. The apparatus for sprouting seeds includes a loading chamber that receives and dispenses a specified amount of seeds, a soaking chamber connected to the loading chamber to soak the seeds with a controlled amount of liquid, a sprouting chamber attached to the soaking chamber to provide a regulated environment for sprouting, and a collection chamber below the sprouting chamber to gather the sprouted seeds once they are fully grown.

The apparatus also includes a controller that manages seed dispensing from the loading chamber to the soaking chamber based on user input or seed type profiles stored in memory. It regulates water levels in the soaking chamber and various environmental conditions in the sprouting chamber according to seed types. Additionally, the controller transfers seeds between chambers and performs operations based on inputs from a user device to which it is connected In an example, the user device can be a cellphone or mobile device associated with a user.

The apparatus controls environmental parameters in the sprouting chamber, including temperature, humidity, and moisture content. It features at least one sprinkler in the sprouting and/or collection chambers to disperse water droplets at preset intervals, operated by the controller. The preset time intervals are based on a humidity requirement for the seeds. As different seed types require different humidity levels for sprouting, the controller chooses the preset intervals based on a type of the seed. Additionally, the controller can transfer sprouted seeds to containers and trigger alerts when the sprouting period is complete and sprouted seeds are present in the collection chamber.

The apparatus receives commands from a user device to control the dispensing of seeds from the loading chamber. It includes a liquid outlet to remove excess liquid from the soaking chamber after the soaking period, with the controller regulating liquid inflow and outflow, timing, and the amount based on seed type and quantity. Additionally, the sprouting chamber features a UV light source to sterilize the seeds at set intervals.

According to another embodiment, a method for sprouting seeds in a sprouting apparatus is disclosed. The method for sprouting seeds using an apparatus involves receiving seeds in a loading chamber, dispensing a predefined quantity into a soaking chamber, soaking them in a predetermined amount of water for a set period, and then transferring them to a sprouting chamber. The method controls environmental parameters within the sprouting chamber to facilitate sprouting and collects the sprouted seeds in a collection chamber after the sprouting period is complete.

The method further includes draining excess water from the soaking chamber after the soaking period. Additionally, a controller manages the dispensing of seeds based on user input or a predefined seed profile, which contains information about seed types and quantities. The controller also regulates water flow into the soaking chamber, environmental conditions in the sprouting chamber, and the transfer of seeds between chambers. It performs operations based on user inputs and utilizes the seed profile to ensure optimal conditions for soaking and sprouting.

Further, the method involves controlling environmental parameters such as temperature, humidity, and moisture content within the sprouting chamber to support seed sprouting. It includes using a sprinkler to disperse water droplets at scheduled intervals in either the sprouting chamber or collection chamber. Additionally, the method facilitates transferring sprouted seeds from the collection chamber to containers, while also triggering alert signals periodically upon completion of the sprouting process and when sprouted seeds are detected in the collection chamber. The process is initiated by commands from a user device connected to the controller, which manages the dispensing of seeds into the soaking chamber through an opening at the lower end of the loading chamber.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram of an environment in which an apparatus for sprouting seeds is operable, according to an example embodiment;

FIG. 2A is a block diagram of the apparatus of FIG. 1, for sprouting seeds, according to an example embodiment;

FIG. 2B is a block diagram of the apparatus of FIG. 1, for sprouting seeds, according to an example embodiment;

FIG. 3 is a flowchart illustrating a method of sprouting seeds, according to an example embodiment; and

FIG. 4 is a flow diagram illustrating operation of the apparatus for sprouting seeds, according to an example embodiment.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skills in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in ‘addition to the orientation depicted in the figures. For example, if the device in the figures is turned over, elements described as “below”, or “beneath” other elements or features would then be oriented “above” the other elements or features. Thus, term such as “below” may encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

At least one example embodiment is generally directed to an apparatus and method for sprouting seeds in a controlled environment and continuously. In particular, the embodiments disclose techniques relating to optimum sprouting of seeds that maintain nutrition at an optimum level.

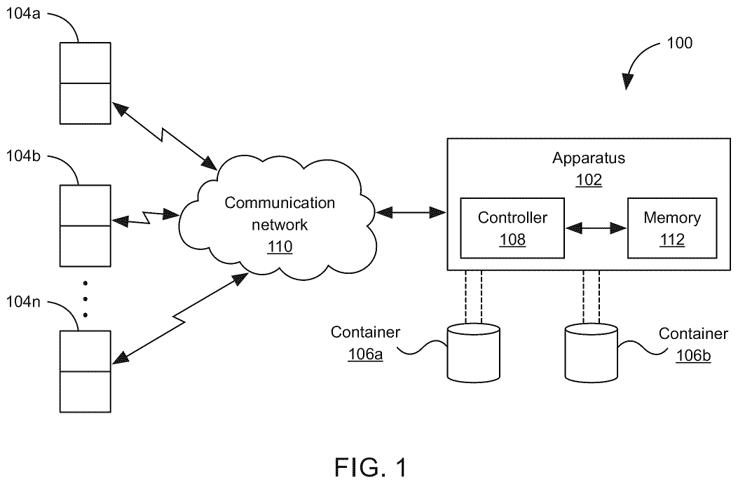

FIG. 1 illustrates an environment 100 in which the apparatus 102 (also referred to as sprouting apparatus) used for sprouting seeds is operated. The environment 100 includes a plurality of user devices 104a-104c, in communication with a controller 108 of the apparatus 102. The environment further includes one or more containers 106a-106b, that store sprouted seeds, once dispensed from the apparatus 102. The user devices 104a-104c are communicatively coupled with the apparatus 102 via a communication network 110. The communication network 110 can be a Bluetooth network, a wired network, a wireless network or any IOT network. Examples of user devices 104a-104n include mobile phones, cell phones, tablets, laptops, computer systems, or any such wireless devices.

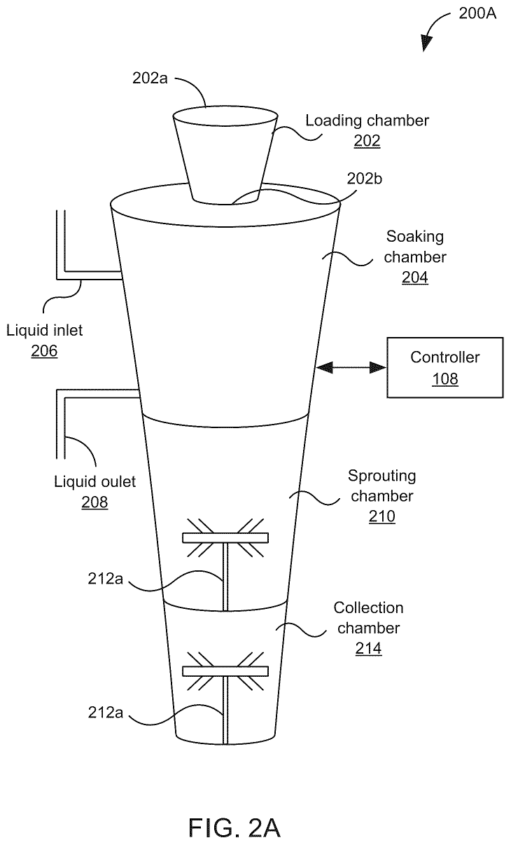

FIG. 2A is a block diagram of the apparatus 102 for sprouting seeds, according to an example embodiment. The apparatus 102 includes a loading chamber 202, a soaking chamber 204, a sprouting chamber 210, a collection chamber 214, at least one sprinkler 212a-212b, a liquid inlet 206, a liquid outlet 208, the controller 108 and the memory 112. The loading chamber 202 is placed on top of the soaking chamber 204. The soaking chamber 204 is placed on top of the sprouting chamber 210, and the sprouting chamber is on top of the collection chamber 214. The controller 108 is communicatively coupled to sensors and actuators (not shown) that are provided within each of the chambers 202, 204, 208 and 214.

The loading chamber 202 has an open upper end 202a, that receives seeds and dispenses a predefined quantity of seeds upon receiving a command by the controller 108. Typically, the loading chamber 202 is disposed in an operative upright position.

The soaking chamber 204 has an upper end 204a engaged with a lower end 202b of the loading chamber 202 to receive the predefined quantity of seeds. The soaking chamber 204 is coupled to the liquid inlet 206 to receive water required for soaking the seeds. Once a predetermined amount of liquid is provided, the controller 108 is operated to close the liquid inlet 206. The predefined quantity of seeds is then allowed to soak for a soaking period. Upon completion of the soaking period, excess water present in the soaking chamber is drained out of the liquid outlet 208. The controller 108 opens the liquid outlet 208 to let the liquid drain out of the liquid outlet 208. The controller 108 then opens a lower portion of the soaking chamber 204 to let the predefined quantity of soaked seeds to move into the sprouting chamber 210.

The sprouting chamber 210 has an upper end engaged with a lower end of the soaking chamber 204 to receive the seeds after completion of the soaking period and maintains a controlled environment during the sprouting period. The controlled environment has a plurality of environmental parameters like temperature, humidity, moisture content controlled at an optimum level as set by the controller 108. The optimum level helps in healthy and fast germination of seeds, and healthy sprouts. An ultraviolet (UV) light source can be installed within the sprouting chamber 210 and configured to sterilize the seeds undergoing sprouting by radiating UV light at predetermined time periods.

The collection chamber 214 is placed below the sprouting chamber 210 and is in operative engagement with a lower end of the sprouting chamber 210. Once the sprouting period completes, the seeds fall from the sprouting chamber 210 to the collection chamber 214. The sprouting chamber 210 and the collection chamber 214, are provided by a sprinkler 212a and 212b respectively, to sprinkle water at predefined time periods as set by the controller 108. The sprinkled water helps in maintaining an optimum moisture level required to retain a freshness level of the sprouts. The controller 108, further triggers an alert signal at one or more time intervals on one or more user devices (104a-104n) upon completion of the sprouting period, and presence of the predefined quantity of sprouting seeds in the collection chamber 214. Upon receiving the alert signal, a user associated with the user device (e.g. 104a) can reach out to the collection chamber 214 and collect the sprouts. In an embodiment, one or more containers (106a-106b) can be coupled in an operative arrangement with the collection chamber 214, and can receive the predefined quantity of seeds, in portions or in whole. For example, the controller 108 can operate an outlet of the collection chamber 214 to release the predefined quantity of sprouted seeds into the container 106a.

In an embodiment, the loading chamber 202, the soaking chamber 204, the sprouting chamber 210 can be funnel shaped to facilitate easy flow of seeds from one chamber to the next. The chambers can be made of food grade steel, stainless steel, plastic or any other material.

The controller 108, basically controls dispensing of the predefined quantity of seeds from the loading chamber 202 to the soaking chamber 204, where the predefined quantity of seeds is based on one of a user input. Further, a quantity of water required for soaking the predefined quantity of seeds is obtained from the controller 108. In an embodiment, the quantity of water is obtained from a seed profile stored in the memory 112 accessible by the controller 108, where the seed profile comprises a mapping of a plurality of predetermined quantity of water with a plurality of predefined quantity of seeds for each seed type. Further, the seed profile comprises a mapping of a soaking period and a sprouting period to each type of a seed, and a mapping of a predetermined quantity of water required to sprout a predefined quantity of seed for each type of seed.

Further, the controller 108, controls a water level in the soaking chamber 204, based on the predefined quantity of seeds and one or more types of the seeds, and controls a plurality of environmental parameters within the sprouting chamber 210 based on the one or more types of the seeds; move the soaked seeds from the soaking chamber 204 to the sprouting chamber 210 after the soaking period, and move the sprouted seeds form the sprouting chamber 210 to the collection chamber 214 after completion of the soaking period. Furthermore, the controller 108 performs one or more operations based on inputs received from the one or more user devices (104a-104n).

In an embodiment, a user can provide specific instructions to the apparatus 102 via the user device 104a. These instructions may include the type and quantity of seeds needed, the desired date for the sprouted seeds, and the frequency of this requirement. For example, a user might specify that 100 grams of sprouted mung beans are required three times a week, every week. Upon receiving these instructions, the controller 108 manages the operations of the apparatus 102 to ensure the required quantity of mung beans is processed as specified. The controller 108 directs 100 grams of mung beans to be loaded into the loading chamber 202. These beans are then transferred to the soaking chamber 204, where they are soaked in 250 ml of water dispensed from the liquid inlet 206. The soaking occurs over a predefined duration of 6 hours in a temperature-controlled environment set at 22° C., as per the data stored in the memory (112) for mung beans.

After the soaking period, the controller 108 opens an outlet at the bottom of the soaking chamber 204, transferring the soaked mung beans to the sprouting chamber 210. In the sprouting chamber 210, the controller 108 manages the sprinkling of water at predefined intervals, maintaining the seeds under conditions suitable for sprouting. At 22° C., the mung beans require 12-14 hours to sprout to a length of approximately 0.5 centimeters. The controller 108 calculates the sprouting duration, sprinkling intervals, and water quantity based on the predefined data for 100 grams of mung beans stored in the seed profile in its memory (112). This ensures efficient soaking, sprouting, and growth, eliminating inaccuracies due to human error. The entire sprouting process is automated, requiring minimal human intervention. The user specifies when the sprouted seeds are needed, and the apparatus handles the rest. Once the sprouting period is complete, the controller 108 opens an outlet at the bottom of the sprouting chamber 210, transferring the sprouted seeds to the collection chamber 214. The controller 108 also sends constant reminders to the user device 104a, prompting the user to collect the sprouted seeds from the collection chamber 214. Another embodiment of the sprouting apparatus is explained further with reference to FIG. 2B.

FIG. 2B illustrates an alternate embodiment of a sprouting apparatus 200B hereinafter referred to as the apparatus 200B for sprouting seeds. As shown, the apparatus 200B includes a plurality of wall mounted seed containers 240a-240d, coupled to the loading chamber by a funnel shaped structure 254. Each seed container (240a-240d) has an output valve (250a-250d) that is controlled by the controller 108. For example, when seeds to type A stored in the seed container 240a are required to be dispensed, the controller 108 operated the output valve 250a into an open position. As a result, seeds of type A, flow through the funnel shaped structure 254 and reach the loading chamber 202. Similarly, seeds of type B, C and D stored in the seed containers 240b-240d, are released and transferred to the loading chamber 202 based on user's requirement.

Typically, the outlet valves 250a-250d are provided at a bottom part of the seed containers 240a-240d. The output valves 250a-250d, are operable by the controller 108 over an IOT network or wi-fi communication network. For example, if the user provides instructions to soak seeds of type A, then the controller 108 operates the output valve 250a into an open position to let the seeds of type A, flow out from the seed container 240a into the funnel 254 that is coupled to a base of all the seed containers 240a-240d. The funnel 254 then tapers into the loading chamber 202.

Hence, in this way the seeds of type A are transferred automatically from the seed container 240a to the loading chamber 202. Such action, is done when a user provides instructions via the controller 108 to load seeds of the type A into the loading chamber 202. Similarly, seeds of type B, C and D can be loaded into the loading chamber 202. In another embodiment (not shown in FIG. 2B), a food pipe is maneuvered by a motor mechanism, to latch onto the output valve 250a-250d, of the seed container 240a-240d respectively, when instructions to load seeds of the type A-D, are received from the user.

Further, once loaded, the seeds are transferred from the loading chamber 202 to the soaking chamber 204, the seeds are collected in a soaking container 204a. Water is then provided via the liquid inlet 204, into the soaking container 204a. An amount of water to be provided is calculated by the controller 108, based on a quantity of seeds present in the soaking container 204a, and a type of the seeds. A value 294d is provided within the liquid inlet 204, that controls flow of water from a water pipe 280 towards an opening of the liquid inlet 204, and into the soaking container 204a. The seeds are then soaked for a predefined time period, in the soaking container 204a, and after the completion of the soaking period, a water drainage valve 284 is opened to drain out any excess water present through the liquid outlet 208. The water drainage valve 284 is designed such that only water and not seeds can flow out. The water drainage valve 284 is then closed, and a seed drainage valve 204b, operated by the controller 108, is opened, to let the seeds fall into a sprouting tray 210a within the sprouting chamber 210.

Typically, the controller 108 is configured to look up a seed profile of the type of seeds present in the memory 112, and calculate the amount of water required for soaking the quantity of seeds that get dispensed into the soaking container. In an embodiment, based on an ambient temperature, and user's feedback received for the type of seeds in a previous iteration of sprouting, the controller 108 is configured to recalculate the amount of water required to optimize the soaking and sprouting process. For example, if for 100 grams of mung beans, the seed profile indicates a quantity of water required for soaking is 200 ml, and an amount of mung beans dispensed in the soaking container 204a is 200 grams, then the controller 108 calculates an amount of water required for soaking the mung beans is 400 ml. However, a user's feedback received in a previous sprouting process of mung beans in the same apparatus 200B, says the mung beans require better soaking or size of sprouted mung beans is small, then the controller 108, is designed to learn that the amount of water required for soaking was less, and could increase the amount of water by 5% to ensure optimized soaking. This takes care of the fact, that different quality of mung beans require slightly different amount of water.

Further, upon completion of soaking, the seeds are transferred from the soaking chamber 204 to the sprouting chamber 210, for sprouting. The sprouting chamber 210, houses the sprouting tray 210a, onto which the seeds are dropped into. The sprouting tray 210a is configured to rotate at a predefined speed, in a clockwise or anticlockwise direction to facilitate shuffling of the seeds during the sprouting process. Basically, the sprouting tray 210a rotates in a clockwise or anticlockwise direction on a plurality of wheels provided at a bottom of the sprouting tray 210. Further, the sprouting tray 210a is operated to rotate at a predefined speed and at predefined time intervals based on commands received by the controller 108. This ensures, that the seeds are well ventilated, and that each seed gets sufficient exposure to air. Such shuffling ensures optimum growth of the sprouts, and increases the efficiency of the sprouting process. Further, water is provided through a pipe 280, into the sprouting tray 210a, via the sprinkler 212a. A water sprinkler valve 294a is provided between the pipe 280 and the sprinkler 212a, to let water flow from the pipe 280 into the sprinkler 212a. The controller 108 controls opening of the water sprinkler valve 294a, when water is required to be sprinkled into the sprouting tray 210a.

Upon completion of the sprouting period, the sprouted seeds are discharged from the sprouting tray 210a, through the seed dispenser valve 210b, into the collection chamber 214a. The controller 108, opens the seed dispenser valve 210b, and the seeds get transferred from the sprouting tray 210a into the collection chamber 214. The collection chamber 214 contains a collection container 214a, into which the sprouted seeds are collected. Water from the pipe 280, is transferred via a water sprinkler valve 294b to a water sprinkler 212b, to let water get sprinkled into the collection container 214a. The water sprinkler valve 294b is operated by the controller 108, into an open position when water is required to be sprinkled into the collection container, and into a closed position when water is not required to be sprinkled. The collection container 214a, can be removed from the container chamber 214, to facilitate collection of the seeds by the user. Post collection of the sprouted seeds from the collection container 214a, excess water present in the pipe 280, is discharged through a waste water valve 294c.

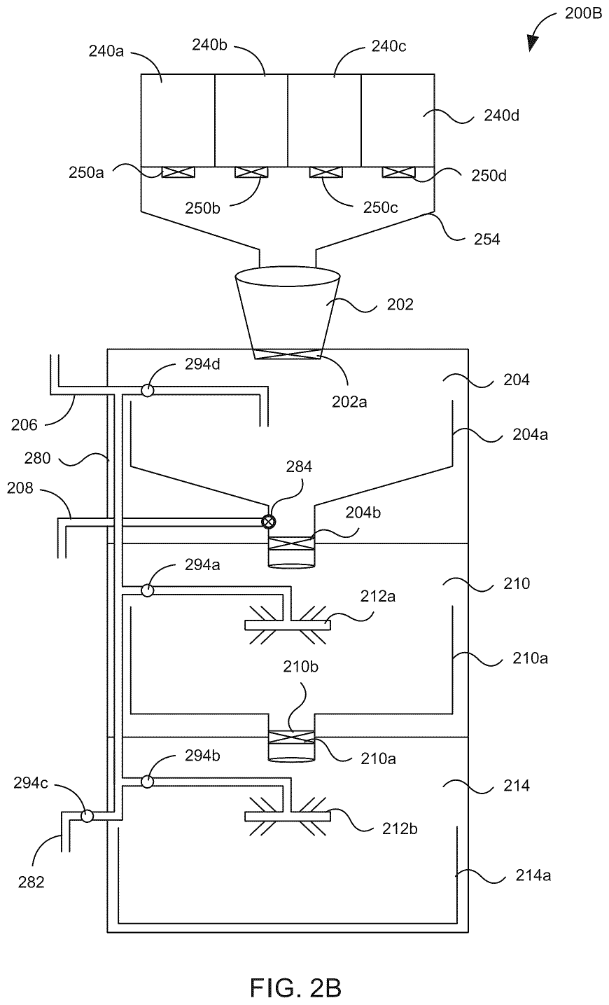

FIG. 3 illustrates a flowchart 300 depicting a method for sprouting seeds, according to an example embodiment.

At 302, seeds of one or more types are received within a loading chamber of a sprouting apparatus. Example of seeds include but are not limited to mung beans, sunflower seeds, horse gram, alfaalfa, broccoli, beet, and chickpea. For example, 250 grams of mung beans can be loaded into the loading chamber. In another example, a combination of 150 grams of mung beans and 100 grams of sunflower beans can be loaded into the loading chamber.

At 304 a predefined quantity of seeds is dispensed into a soaking chamber and is operatively coupled to the loading chamber. For example, if a user needs 100 grams of sprouts, then the predefined quantity can be set to 100 grams via a user interface. Accordingly, a controller facilitates a transfer of 100 grams of seeds into the soaking chamber. In an embodiment, an outlet of the loading chamber is opened through which the seeds pass through and reach the soaking chamber. Once the predefined quantity of seeds gets passed through the outlet, the controller operatively closes the outlet, to ensure only the predefined quantity is dispensed. Sensors can be provided at the outlet to receive open and close command signals from the controller, and an actuator can be coupled to the outlet to open and close it upon receiving the open and close command signals respectively.

At 306, the predefined quantity of seeds is soaked in a predetermined quantity of water for a soaking period. The predetermined quantity of water for a type of seed and the predefined quantity of seeds is obtained from a seed profile associated with the type of seed. For example, for mung beans of 150 grams, the predetermined quantity of water required can be 250 ml.

At 308, the predefined quantity of soaked seeds is transferred into a sprouting chamber that is operatively coupled to the soaking chamber, after completion of the soaking period. The soaking period is obtained from the seed profile.

At 310, a plurality of environmental parameters is controlled within the sprouting chamber for a sprouting period associated with the seeds to facilitate sprouting of the predefined quantity of soaked seeds. In an embodiment, a temperature, humidity and moisture content of the sprouting chamber can be controlled by the controller by referring to the seed profile.

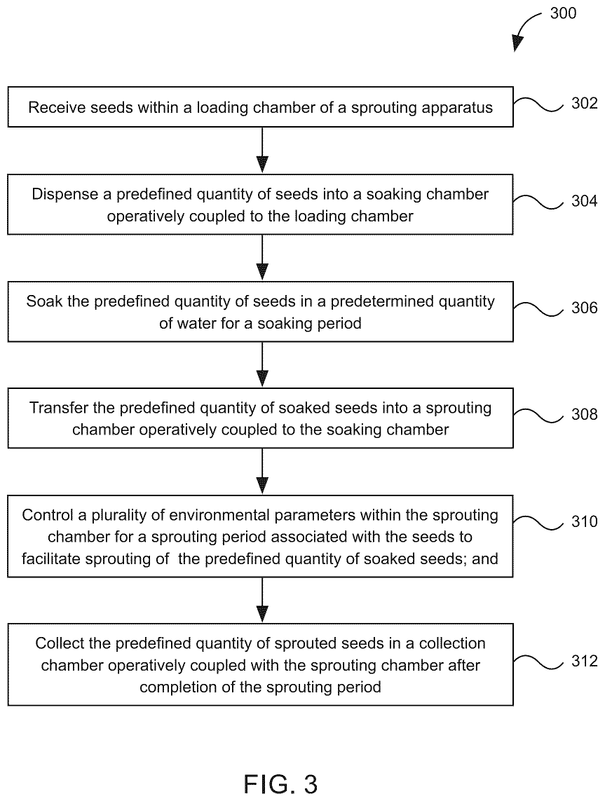

At 312, the predefined quantity of sprouted seeds is collected in a collection chamber that is operatively coupled with the sprouting chamber, after completion of the sprouting period. A detailed flow diagram of steps involved in the process of sprouting is explained with referee to FIG. 4.

FIG. 4 illustrates a flow diagram 400A-400B illustrating a detailed process of how seeds are sprouted in a sprouting apparatus.

At 402, seeds are received within a loading chamber. The seeds can be of one type (e.g. mung beans) or a plurality of types such as horse gram seeds and mung beans.

At 404, a controller checks whether an amount of beans received is sufficient. Incase the amount of seeds received is not sufficient, the method flows to step 405. Incase the amount of seeds is sufficient the method flows to step 406.

At 405, an alert signal is sent to a user device, indicating additional quantity of seeds needs to be loaded into the loading chamber.

At 406, a predefined quantity of seeds required to be spouted is provided to the controller, by the user device. Alternatively, the predefined quantity of seeds as stored in a memory is retrieved by the controller.

At 408, the predefined quantity of seeds is dispensed into a soaking chamber.

At 410, the predefined quantity of seeds is soaked in a predetermined quantity of water for a soaking period. Typically, a liquid inlet shall be opened to let the predetermined quantity of liquid (e.g. water) flow into the soaking chamber. Once the predetermined quantity of water gets filled in the soaking chamber, the liquid inlet is closed.

At 412, excess water is drained out of this soaking chamber upon completion of the soaking period. The excess water can be drained through a liquid outlet, that is opened upon completion of the soaking period, and is closed when all the excess water gets drained. Sensors can be provided within the soaking chamber to alert the controller of an amount of water level within the soaking chamber. Based on the water level, the beginning and end of the soaking period, the controller provides control signals to open or close the liquid inlet, and open or close the liquid outlet.

At 414, the predefined quantity of soaked seeds is then transferred into a sprouting chamber, that is coupled to the soaking chamber.

At 416, a plurality of environmental parameters is controlled in the sprouting chamber for a sprouting period. For example, humidity, temperature and moisture content is controlled within the sprouting period to a level that optimizes the germination of the seeds and healthy growth of sprouts.

At 418, water droplets are dispersed or sprinkled at predefined time periods during the sprouting period.

At 420, the predefined quantity of sprouted seeds is sterilized in the sprouting chamber by radiating with an ultraviolet light for a predetermined time duration. The UV light helps in providing an anti-fungal and anti-bacterial treatment, to ensure healthy sprouts.

At 422, the predefined quantity of seeds is collected in a collection chamber.

At 424, an alert signal is triggered by the controller at one or more time intervals indicating presence of the predefined quantity of sprouted seeds in the collection chamber, and instructions to collect the seeds. In an embodiment, the one or more time intervals can be a period of 20 minutes or 60 minutes. So, every 20 minutes or 60 minutes the alert signal is given to the user to collect the sprouted seeds.

The seed profile is a table look-up that comprises a mapping of a plurality of types of seeds to the predetermined quantity of water required for soaking, a plurality of environment parameters required for sprouting, a soaking period, and a sprouting period with a quantity of seeds and one or more types of the seeds.

The sprouting apparatus offers numerous advantages through its advanced automation and control systems. Its novelty lies in the fact that beans are autoloaded, and the entire sprouting process is continuous and autonomous, eliminating the need for manual intervention. The apparatus features a loading chamber capable of dispensing a predefined quantity of seeds automatically based on user input or preset configurations, ensuring precise and consistent seed quantities for optimal sprouting. The soaking chamber receives a predetermined amount of liquid to soak the seeds, with the process meticulously managed by a liquid inlet and outlet. This automation guarantees that seeds are soaked for the correct duration and with the appropriate amount of water, enhancing sprouting efficiency and consistency.

The sprouting chamber is designed to maintain a controlled environment tailored to the specific needs of different seed types. Parameters such as temperature, humidity, and moisture are regulated to create optimal conditions for seed germination and growth. Once the sprouting period is complete, the sprouted seeds are automatically transferred to a collection chamber, simplifying the harvesting process and reducing manual labor. The bodies of the chambers are made of steel, copper, or any food-grade material like plastic, which helps maintain the nutrition of the seeds and promotes health and safety in consumption.

An advanced control system manages various functions of the apparatus, including seed dispensing, water levels, and environmental conditions within the sprouting chamber. This system can receive commands from a user device, allowing for remote operation and monitoring. Additionally, the apparatus can store profiles for different seed types, mapping specific quantities of seeds, soaking times, water amounts, and environmental conditions. This customization ensures that each seed type receives the optimal treatment for sprouting.

Water management is another key feature, with excess water from the soaking chamber automatically drained after the soaking period to prevent waterlogging and ensure seeds are in ideal condition for sprouting. The sprouting chamber includes an ultraviolet (UV) light source that sterilizes the seeds during sprouting, reducing contamination risks and promoting healthier growth. The system can trigger alerts at specific intervals to notify users when the sprouting process is complete or if any intervention is required, enhancing user convenience and ensuring timely actions.

The built-in sprinkler system disperses water droplets at predefined intervals within the sprouting and collection chambers, maintaining necessary moisture levels and further automating seed care. The controller's ability to communicate with a user device allows for remote control and monitoring of the entire sprouting process. Users can adjust settings, monitor progress, and receive alerts from anywhere, enhancing convenience and flexibility.

The apparatus ensures efficient use of resources by precisely controlling water use and environmental conditions based on seed profiles, reducing waste and optimizing the sprouting process. The high level of automation significantly reduces the need for manual intervention, saving time and effort for users. With the automated transfer of seeds between chambers and the management of environmental conditions, the entire process from start to finish is streamlined. Furthermore, the ability to store and manage multiple seed profiles allows for the sprouting of different seed types without manual recalibration, making the apparatus scalable and versatile for various user needs.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other examples features of example embodiments may be embodied in the form of an apparatus, method, system, computer program, tangible computer readable medium and tangible computer program product. For example, the aforementioned methods may be embodied in the form of a system or device, including, but not limited to, any of the structures for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device's main body or a removable medium arranged so that it may be separated from the computer device's main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

We claim:

1. An apparatus for sprouting seeds, the apparatus comprising:
a loading chamber having an open upper end structured to receive seeds and to dispense a predefined quantity of seeds upon receiving a command, wherein the loading chamber is disposed in an operative upright position;
a soaking chamber having an upper end engaged with a lower end of the loading chamber to receive the predefined quantity of seeds;
a liquid inlet coupled to the soaking chamber and configured to provide a predetermined amount of liquid into the soaking chamber for soaking the predefined quantity of seeds,
a sprouting chamber having an upper end engaged with a lower end of the soaking chamber to receive the seeds after completion of the soaking period, and maintain a controlled environment for a sprouting period required for sprouting the seeds; and
a collection chamber coupled to a lower end of the sprouting chamber and configured to receive the sprouted seeds upon completion of the sprouting period.

2. The apparatus of claim 1, further comprising:
a controller configured to:
control dispensing of the predefined quantity of seeds from the loading chamber to the soaking chamber, wherein the predefined quantity of seeds is based on one of a user input, and a predefined quantity associated with a type of the seed, wherein the predefined quantity is obtained from a seed profile stored in a memory accessible by the controller, and wherein the seed profile comprises a mapping of a plurality of predefined quantities with a plurality of seed types;
control a water level in the soaking chamber based on the predefined quantity of seeds and one or more types of the seeds;
control a plurality of environmental parameters within the sprouting chamber based on the one or more type of the seeds;
move the soaked seeds from the soaking chamber to the sprouting chamber after the soaking period;
move the sprouted seeds form the sprouting chamber to the collection chamber after completion of the soaking period; and
perform one or more operations based on inputs received from a user device, wherein the controller is communicatively coupled to the user device.

3. The system of claim 2, wherein the plurality of environmental parameters comprise a temperature, a humidity level, and a moisture content of a space contained within the sprouting chamber.

4. The system of claim 2, further comprising:
at least one sprinkler positioned in one or more of the sprouting chamber and the collection chamber, configured to disperse water droplets internally at predefined time periods, and wherein the controller is configured to operate the at least one sprinkler and a water flow required for dispersing the water droplets.

5. The system of claim 2, wherein the controller is further configured to perform one or more of:
transfer the sprouted seeds from the collection chamber to one or more containers;
trigger an alert signal at one or more time intervals upon completion of the sprouting period and presence of sprouted seeds in the collection chamber.

6. The system of claim 1, wherein the command is received from a user device that is communicatively coupled to the controller; and wherein the controller is configured to control an opening at a lower end of the loading chamber to dispense the predefined quantity of seeds.

7. The system of claim 2, further comprising:
liquid outlet coupled to the soaking chamber that is configured to remove excess liquid from the second chamber upon completion of a soaking period associated with the seeds, and wherein the controller is disposed in an operative arrangement with the liquid inlet for regulating an inflow of the liquid into the soaking chamber, an outflow of the excess liquid from the soaking chamber, a timing for delivering the liquid and removing the liquid from the soaking chamber, and an amount of liquid for soaking the seeds, wherein each seed type and quantity of seeds is associated with a predetermined amount of liquid required during the soaking period.

8. The system of claim 1, wherein the sprouting chamber includes an ultraviolet (UV) light source configured to sterilize the seeds undergoing sprouting by radiating UV light at predetermined time periods.

9. The system of claim 2, wherein the sprouting chamber houses a tray configured to receive the soaked seeds, and rotate in a clockwise or anticlockwise direction on a plurality of wheels provided at a bottom of the tray, and wherein the tray is operated to rotate at a predefined speed and at predefined time intervals based on commands received by the controller.

10. A method for sprouting seeds using a sprouting apparatus, the method comprising:
receiving seeds within a loading chamber of the sprouting apparatus;
dispensing a predefined quantity of seeds into a soaking chamber operatively coupled to the loading chamber;
soaking the predefined quantity of seeds in a predetermined quantity of water for a soaking period;
transferring the predefined quantity of soaked seeds into a sprouting chamber operatively coupled to the soaking chamber;
controlling a plurality of environment parameters within the sprouting chamber for a sprouting period associated with the seeds to facilitate sprouting of the predefined quantity of soaked seeds; and
collecting the predefined quantity of sprouted seeds in a collection chamber operatively coupled with the sprouting chamber after completion of the sprouting period.

11. The method of claim 10, further comprising:
draining excess water from the soaking chamber upon completion of the soaking period.

12. The method of claim 10, further comprising:
controlling, by a controller, dispensing of the predefined quantity of seeds from the loading chamber to the soaking chamber, wherein the predefined quantity of seeds is based on one of a user input, and a predefined quantity associated with a type of the seed, wherein the predefined quantity is obtained from a seed profile stored in a memory accessible by the controller, and wherein the seed profile comprises a mapping of a plurality of predefined quantities with a plurality of seed types;
facilitating, by the controller, flow of water into the soaking chamber based on the seed profile, wherein the predetermined quantity of water required for soaking is obtained from the seed profile;
controlling, by the controller, a plurality of environmental parameters within the sprouting chamber based on the seed profile;
transferring, by the controller, the soaked seeds from the soaking chamber to the sprouting chamber after the soaking period;
transferring, by the controller, the sprouted seeds form the soaking chamber to the collection chamber after completion of the soaking period; and
performing, by the controller, one or more operations based on inputs received from a user device, wherein the controller is communicatively coupled to the user device; and wherein the seed profile further comprises a mapping of the predetermined quantity of water required for soaking, the plurality of environment parameters, a soaking period, and a sprouting period with a quantity of seeds and one or more types of the seeds.

13. The method of claim 10, wherein the plurality of environmental parameters comprise a temperature, a humidity level, and a moisture content of a space contained within the sprouting chamber.

14. The method of claim 10, further comprising:
dispersing water droplets, by a sprinkler, at predefined time periods in one or more of the sprouting chamber and the collection chamber.

15. The method of claim 12, further comprising:
transferring, by the controller, the sprouted seeds from the collection chamber to one or more containers;
triggering, by the controller, an alert signal at one or more time intervals upon completion of the sprouting period and presence of sprouted seeds in the collection chamber.

16. The method of claim 12, wherein the command is received from a user device that is communicatively coupled to the controller, and wherein the controller is configured to control an opening at a lower end of the loading chamber to dispense the predefined quantity of seeds into the soaking chamber.
